(19) United States
(12) Patent Application Publication
(10) Pub. No.: US 2026/0011003 A1
(43) Pub. Date: Jan. 8, 2026

(54) CHEST X-RAY IMAGE ANALYZING SYSTEM AND METHOD THEREOF

(71) Applicants: NATIONAL YUNLIN UNIVERSITY OF SCIENCE AND TECHNOLOGY, YUNLIN COUNTY (TW); Buddhist Tzu Chi Medical Foundation, Hualien County (TW)

(72) Inventors: Chuan-Yu CHANG, Yunlin County (TW); Jyun-Shuo CHEN, Kaohsiung City (TW); Chun-Liang LAI, Chiayi County (TW)

(21) Appl. No.: 18/764,364

(22) Filed: Jul. 5, 2024

(30) Foreign Application Priority Data
Jul. 4, 2024 (TW) 113125088

(51) Int. Cl. G06T 7/00

(52) U.S. Cl. CPC G06T 7/0012; G06T 2207/10116; G06T 2207/30004

(57) ABSTRACT

A chest X-ray image analyzing system includes a memory and a processor. The memory stores a first judgment model and a second judgment model. The processor inputs the X-ray image into the first judgment model to divide the X-ray image into a plurality of grids, and obtains a mark of the X-ray image from the plurality of grids. The processor judges whether the X-ray image is flipped based on the mark to generate a preliminary determination result. The processor inputs the X-ray image into the second judgment model based on the preliminary determination result to extract the features of a plurality of organs in the X-ray image to obtain an organ status.

### RELATED APPLICATIONS

This application claims priority to Taiwan Application Serial Number 113125088, filed Jul. 4, 2024, which is herein incorporated by reference.

### BACKGROUND

### Technical Field

The present disclosure relates to an image analyzing system and an image analyzing method. More particularly, the present disclosure relates to a chest X-ray image analyzing system and method thereof.

### Description of Related Art

Situs Inversus Totalis (SIT) is a rare congenital organ condition, mainly in which the organs in the thoracoabdominal cavity are mirror-image inverted. When a patient undergoes medical treatment such as visceral surgery or organ transplantation, medical negligence may easily result if the organ inversion is not detected.

Medical personnel can confirm whether the patient has SIT by reviewing the patient's chest X-ray image. Generally, the X-ray image has an Anatomical Side Maker (ASM), which is used by the medical personnel to check whether the medical imaging is in a normal direction.

If the X-ray image is a flipped image or the ASM is incorrect, it will cause the medical personnel to misinterpret the X-ray image, which will lead to incorrect diagnosis.

In view of this, there is currently a lack of a chest X-ray image analyzing system and method thereof on the market that can assist the medical personnel in interpreting the X-ray image. Therefore, the relevant industries are looking for the solution.

### SUMMARY

According to one aspect of the present disclosure, a chest X-ray image analyzing system is configured to analyze an X-ray image of a subject, and includes a memory and a processor. The memory stores a first judgment model and a second judgment model. The processor is coupled to the memory, and performs operations includes the following steps. The processor inputs the X-ray image into the first judgment model to divide the X-ray image into a plurality of grids, and obtains a mark of the X-ray image from the plurality of grids. The processor judges whether the X-ray image is flipped based on the mark to generate a preliminary determination result. The processor inputs the X-ray image into the second judgment model based on the preliminary determination result to extract a plurality of features of a plurality of organs in the X-ray image to obtain an organ status.

According to another aspect of the present disclosure, a chest X-ray image analyzing method is configured to analyze an X-ray image of a subject, and includes the following steps. Inputting the X-ray image into a first judgment model from a processor to divide the X-ray image into a plurality of grids, and obtaining a mark of the X-ray image from the plurality of grids. Judging whether the X-ray image is flipped from the processor based on the mark to generate a preliminary determination result. Inputting the X-ray image into a second judgment model from the processor based on the preliminary determination result to extract a plurality of features of a plurality of organs in the X-ray image to obtain an organ status.

### BRIEF DESCRIPTION OF THE DRAWINGS

FIG. 1 is a chest X-ray image analyzing system according to the 1st embodiment of the present disclosure;

FIG. 2A is a schematic diagram of an X-ray image of the present disclosure;

FIG. 2B is another schematic diagram of the X-ray image of the present disclosure;

FIG. 3 is a block flow chart of a chest X-ray image analyzing method according to the 2nd embodiment of the present disclosure;

FIG. 4A is a schematic diagram of an organ status obtained through the chest X-ray image analyzing method in FIG. 3;

FIG. 4B is a schematic diagram of another organ status obtained through the chest X-ray image analyzing method in FIG. 3;

FIG. 4C is a schematic diagram of further another organ status obtained through the chest X-ray image analyzing method in FIG. 3;

FIG. 4D is a schematic diagram of yet another organ status obtained through the chest X-ray image analyzing method in FIG. 3; and

FIG. 5 is a flow chart of the chest X-ray image analyzing method according to FIG. 3.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

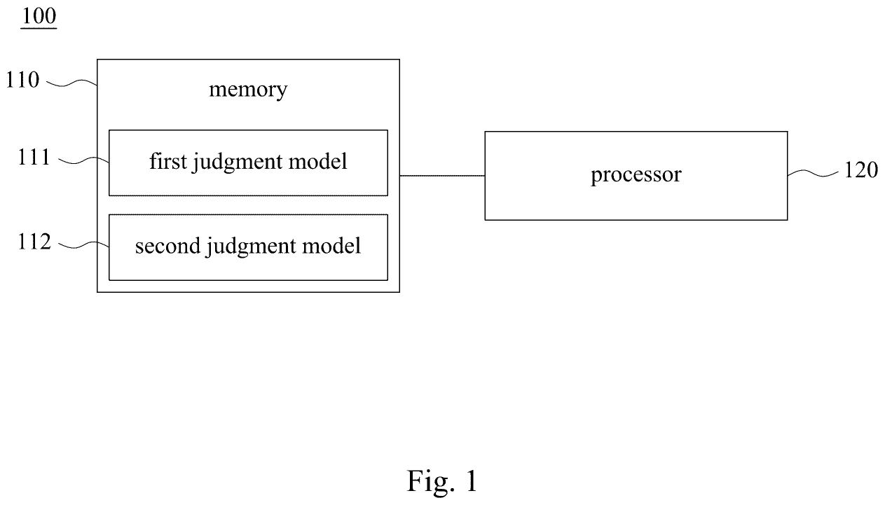

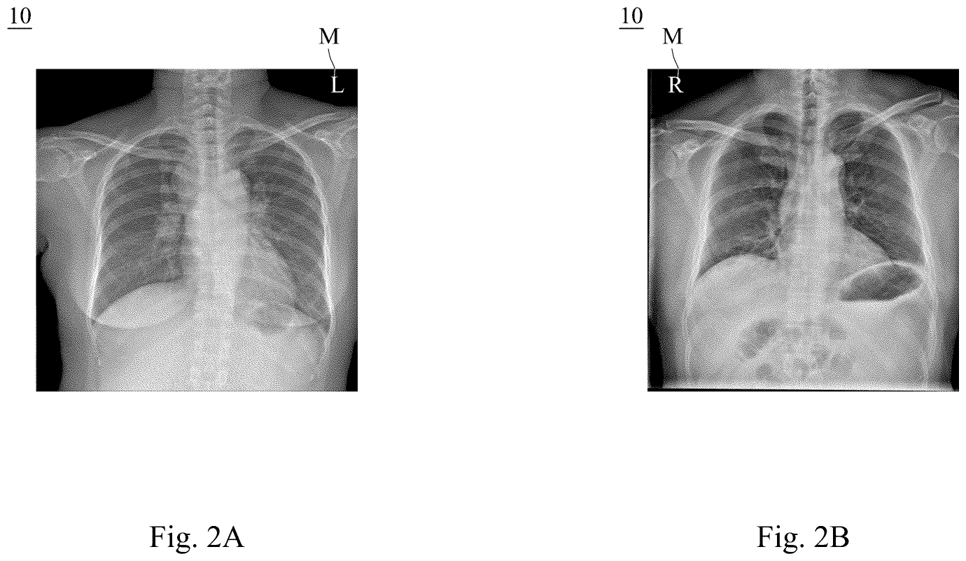

Please refer to FIG. 1, FIG. 2A and FIG. 2B. FIG. 1 is a chest X-ray image analyzing system 100 according to the 1st embodiment of the present disclosure. FIG. 2A is a schematic diagram of an X-ray image 10 of the present disclosure. FIG. 2B is another schematic diagram of the X-ray image 10 of the present disclosure. The chest X-ray image analyzing system 100 includes a memory 110 and a processor 120, the processor 120 is coupled to the memory 110. The memory 110 stores a first judgment model 111 and a second judgment model 112. The first judgment model 111 is a YOLOv5 model with an attention mechanism, the second judgment model 112 is a ResNeSt model. After the processor 120 receives the X-ray image 10 of the subject, the processor 120 inputs the X-ray image 10 into the first judgment model 111 to obtain the mark M of the X-ray image 10 and judge whether the X-ray image 10 is flipped to generate a preliminary determination result. The processor 120 then inputs the X-ray image 10 into the second judgment model 112 based on the preliminary determination result to obtain the organ status of the subject. In the 1st embodiment, the organ status is configured to assist the medical personnel to identify whether the subject has the situation of SIT, but the present disclosure is not limited thereto.

In detail, the mark M of the X-ray image 10 is ASM, which is used to provide clinical confirmation of the condition for correct diagnosis and treatment. The mark M “L” represents the left side of the subject, and is always in the upper right of the X-ray image 10 (as shown in FIG. 2A); the mark M “R” represents the right side of the subject, and is always in the upper left of the X-ray image 10 (as shown in FIG. 2B).

Moreover, in the 1st embodiment, the memory 110 can be a Random Access Memory (RAM) or another type of dynamic storage device that can store information and instructions for execution by the processor 120. The processor 120 can be a microprocessor, a Central Processing Unit (CPU), a computer, a mobile device processor, a cloud processor or other electronic computing processors, but the present disclosure is not limited thereto.

Hence, analyzing the X-ray image 10 through the chest X-ray image analyzing system 100 can assist the medical personnel in subsequent identification of the X-ray image 10 of the chest and avoid the X-ray image 10 being reversed, which would cause the problem of the medical personnel misinterpret the X-ray image 10 and lead to diagnostic errors.

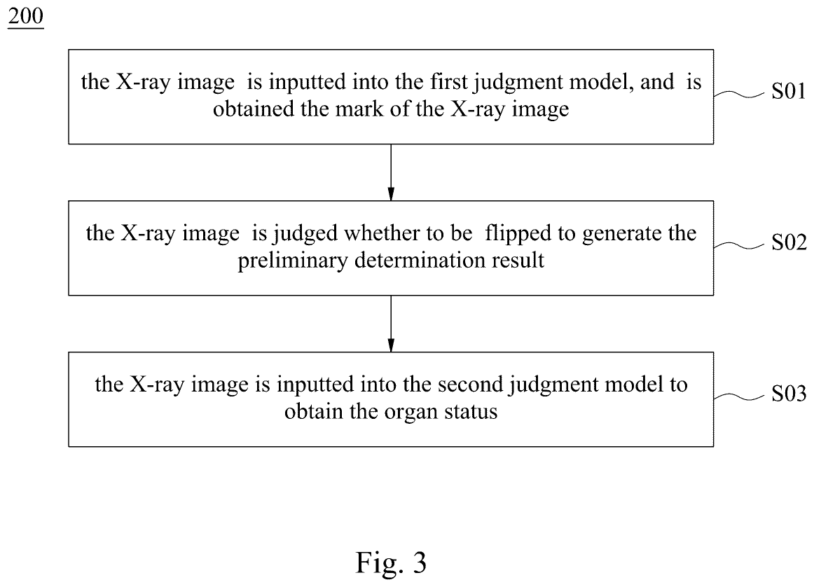

Please refer to FIG. 1 to FIG. 3. FIG. 3 is a block flow chart of a chest X-ray image analyzing method 200 according to the 2nd embodiment of the present disclosure. The chest X-ray image analyzing system 100 is configured to implement the chest X-ray image analyzing method 200, which is configured to analyze an X-ray image 10 of a subject and is favorable for assisting the medical personnel to confirm the organ status of the subject. It should be noted that, the chest X-ray image analyzing method 200 of the present disclosure is not limited to be implemented by the chest X-ray image analyzing system 100 of the present disclosure.

The chest X-ray image analyzing method 200 includes step S01, step S02 and step S03, which are executed in sequence. In the step S01, the X-ray image 10 is inputted into the first judgment model 111 from a processor 120 to divide the X-ray image 10 into a plurality of grids, and the mark M of the X-ray image 10 is obtained from the plurality of grids. The first judgment model 111 is a YOLOv5 model, the first judgment model 111 extracts the local features and the global features of the X-ray image 10 through a deep Convolutional Neural Network (CNN), and detects multiple targets at the same time, and assigns corresponding categories and bounding boxes to each target.

The first judgment model 111 includes a backbone layer, a neck layer and a head layer that are connected to each other. The backbone layer adopts the CSPNet structure with an attention mechanism, which is a simple, parameter-free attention module for convolutional neural networks (SimAM). The backbone layer is configured to capture the features of the mark M of the X-ray image 10 better. The neck layer adopts the Bidirectional Feature Pyramid Network (BiFPN) structure, and is configured to identify different sizes of the mark M to improve the identification performance. The head layer is configured to obtain the confidence level, the category and the coordinate corresponding to the mark M.

In detail, the mark M of the X-ray image 10 may have different letter symbols or sizes depending on the hospital where the image was taken or radiographer who took the image. In order to avoid the misjudgment by the first judgment model 111 caused by the differences in letter symbols, the first judgment model 111 can identify the mark M more intensively through the attention mechanism. In order to avoid the misjudgment by the first judgment model 111 caused by the sizes in letter symbols, the first judgment model 111 can capture the features of multiple sizes of the mark M without increasing too many parameters and calculations through the BiFPN structure.

Hence, through the object detection of the first judgment model 111, it can determine the category of the mark M of the X-ray image 10 is “left” or “right” quickly, and obtain the position of the mark M at the same time.

In the step S02, the X-ray image 10 is judged whether to be flipped from the processor 120 based on the mark M to generate a preliminary determination result. The processor 120 confirms whether the position of the mark M is correct based on the category and the coordinate corresponding to the mark M, and determines whether the X-ray image 10 is flipped.

For example, as shown in FIG. 2A, the mark M of the X-ray image 10 is “L” and is located on the upper right side. After the processor 120 inputs the X-ray image 10 into the first judgment model 111, it can obtain that the category of the mark M of the X-ray image 10 is left, and the coordinate is located in the upper right of the X-ray image 10. Since, in normal situation, mark representing the left side of the subject must be located at the upper right in the X-ray image 10, the processor 120 can confirm that the position of the mark M is correct and determine that the X-ray image 10 is not flipped, and the preliminary determination result is no.

In contrast, if the category of the mark M of the X-ray image 10 obtained by the processor 120 is left, and the coordinate is located in the upper left of the X-ray image 10. The processor 120 can confirm that the position of the mark M is wrong and determine that the X-ray image 10 is flipped (or reversed), and the preliminary determination result is yes. Hence, the position of the mark M can be accurately determined through the preliminary determination result and is favorable for subsequently interpreting the X-ray image 10.

In the step S03, the X-ray image 10 is inputted into the second judgment model 112 from the processor 120 based on the preliminary determination result to extract a plurality of features of a plurality of organs in the X-ray image 10 to obtain the organ status. The obtained organ status is configured to assist the medical personnel to interpret the X-ray image 10 and confirm whether the subject has the situation of SIT.

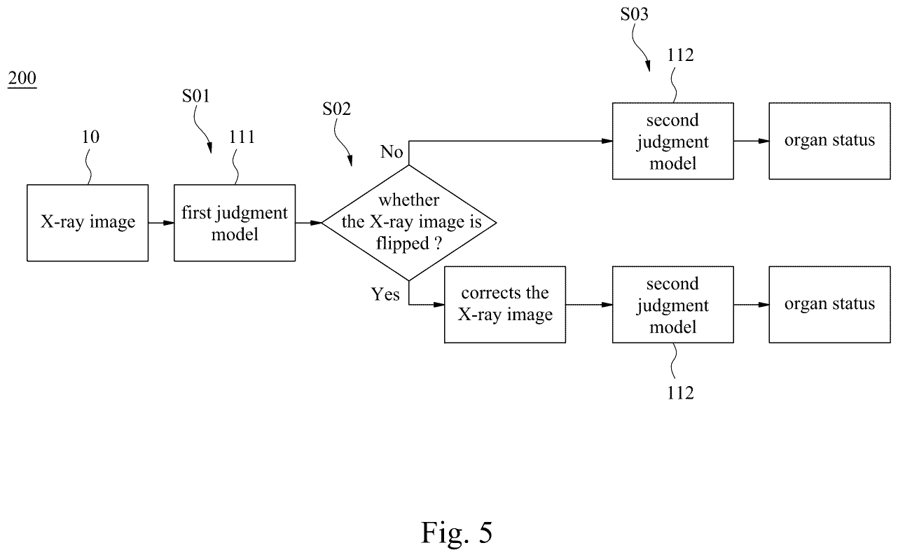

It should be noted that, the detailed features and sequence of the processor 120 inputting the X-ray image 10 to the second judgment model 112 based on the preliminary determination result will be described in FIG. 5 below.

The second judgment model is a ResNeSt model, which is trained based on the ChestX-ray14 data with a large number of lung image datasets labeled with different lung disease labels (such as pneumothorax, pneumonia, pulmonary edema, hernia, etc.). Moreover, during the model training process, in order to make the model more generalizable, CutMix is used for data enhancement to enhance the robustness of the second judgment model 112. The second judgment model 112 divides the channels which input the X-ray image 10 into multiple groups through the group convolution operation, and performs the convolution operation on each group respectively, and adds the output of each group in the end. Hence, in addition to reducing the number of parameters, it also enables the convolution kernel between different groups to learn different features so as to strength the correlation between different channels.

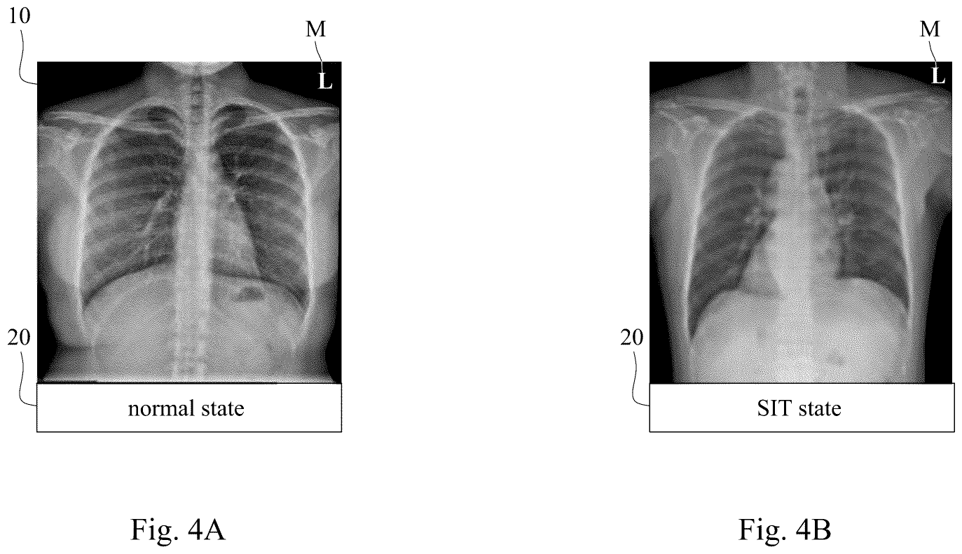

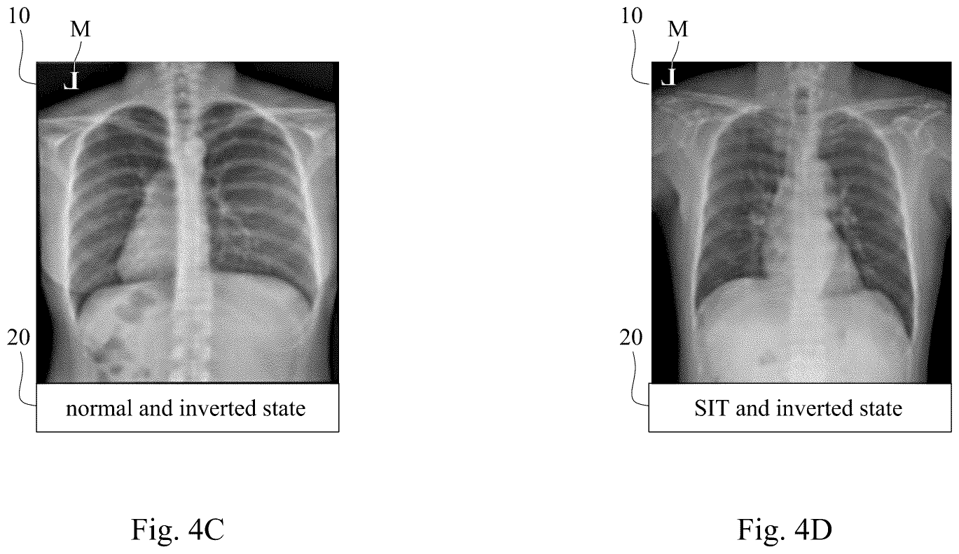

Please refer to FIG. 1, FIG. 3 and FIG. 4A to FIG. 4D. FIG. 4A is a schematic diagram of the organ status obtained through the chest X-ray image analyzing method 200 in FIG. 3. FIG. 4B is a schematic diagram of another organ status obtained through the chest X-ray image analyzing method 200 in FIG. 3. FIG. 4C is a schematic diagram of further another organ status obtained through the chest X-ray image analyzing method 200 in FIG. 3. FIG. 4D is a schematic diagram of yet another organ status obtained through the chest X-ray image analyzing method 200 in FIG. 3. The organ status output by the second judgment model 112 includes the X-ray image 10 and an analysis result 20 corresponding to the X-ray image 10. The analysis result 20 includes normal state (as shown in FIG. 4A), SIT state (as shown in FIG. 4B), normal and inverted (or flipped) state (as shown in FIG. 4C), and SIT and inverted (or flipped) state (as shown in FIG. 4D).

Take the category of mark M as “left” as an example. As shown in FIG. 4A, when the X-ray image 10 is confirmed to be correct in the position of the mark M through the first judgment model 111, and confirmed to be correct in the position of the organ through the second judgment model 112, the analysis result 20 is displayed as “normal state”. As shown in FIG. 4B, when the X-ray image 10 is confirmed to be correct in the position of the mark M through the first judgment model 111, and confirmed to be inverse in the position of the organ through the second judgment model 112, the analysis result 20 is displayed as “SIT state”. As shown in FIG. 4C, when the X-ray image 10 is confirmed to be wrong in the position of the mark M through the first judgment model 111, and confirmed to be correct in the position of the organ through the second judgment model 112, the analysis result 20 is displayed as “normal and inverted state”. As shown in FIG. 4D, when the X-ray image 10 is confirmed to be wrong in the position of the mark M through the first judgment model 111, and confirmed to be inverse in the position of the organ through the second judgment model 112, the analysis result 20 is displayed as “SIT and inverted state”.

Hence, it can assist the medical personnel to identify X-ray image 10 of the chest so as to confirm whether the subject has the situation of SIT.

Please refer to FIG. 1, FIG. 3 and FIG. 5. FIG. 5 is a flow chart of the chest X-ray image analyzing method 200 according to FIG. 3. In the step S02, the processor 120 judges whether the X-ray image 10 is flipped based on the mark M to generate the preliminary determination result. When the preliminary determination result is yes, it means the X-ray image 10 is flipped, the processor 120 corrects the X-ray image 10 immediately, flips the X-ray image 10 to return the mark M to the original position, and inputs the X-ray image 10 into the second judgment model 112. When the preliminary determination result is no, it means the X-ray image 10 is not flipped, the processor 120 inputs the X-ray image 10 into the second judgment model 112 directly.

In view of the above, the present disclosure has the following advantages. First, by checking the organ status output by the second judgment model, it can assist the medical personnel to interpret the X-ray image quickly, and avoid the problem of the diagnostic errors effectively so as to improve the stability of treatment. Second, by the analysis method that combines object detection and classification model output through the first judgment model and the second judgment model, it can judge the X-ray images with SIT more accurately.

Although the present disclosure has been described in considerable detail with reference to certain embodiments thereof, other embodiments are possible. It will be apparent to those skilled in the art that various modifications and variations can be made to the structure of the present disclosure without departing from the scope or spirit of the disclosure. Therefore, it is intended that the present disclosure cover modifications and variations of this disclosure provided they fall within the scope of the following claims.

What is claimed is:

1. A chest X-ray image analyzing system, which is configured to analyze an X-ray image of a subject, and comprising:
a memory storing a first judgment model and a second judgment model; and
a processor coupled to the memory, and performing operations comprising:
inputting the X-ray image into the first judgment model to divide the X-ray image into a plurality of grids, and obtaining a mark of the X-ray image from the plurality of grids;
judging whether the X-ray image is flipped based on the mark to generate a preliminary determination result; and
inputting the X-ray image into the second judgment model based on the preliminary determination result to extract a plurality of features of a plurality of organs in the X-ray image to obtain an organ status.

2. The chest X-ray image analyzing system of claim 1, wherein the first judgment model is a YOLOv5 model with an attention mechanism.

3. The chest X-ray image analyzing system of claim 1, wherein the processor confirms whether a position of the mark is correct based on a category and a coordinate corresponding to the mark, and determines whether the X-ray image is flipped.

4. The chest X-ray image analyzing system of claim 1, wherein,
when the preliminary determination result is yes, the processor corrects the X-ray image and inputs the X-ray image into the second judgment model;
when the preliminary determination result is no, the processor inputs the X-ray image into the second judgment model directly.

5. The chest X-ray image analyzing system of claim 4, wherein the second judgment model is a ResNeSt model.

6. A chest X-ray image analyzing method, which is configured to analyze an X-ray image of a subject, and comprising:
inputting the X-ray image into a first judgment model from a processor to divide the X-ray image into a plurality of grids, and obtaining a mark of the X-ray image from the plurality of grids;
judging whether the X-ray image is flipped from the processor based on the mark to generate a preliminary determination result; and
inputting the X-ray image into a second judgment model from the processor based on the preliminary determination result to extract a plurality of features of a plurality of organs in the X-ray image to obtain an organ status.

7. The chest X-ray image analyzing method of claim 6, wherein the first judgment model is a YOLOv5 model with an attention mechanism.

8. The chest X-ray image analyzing method of claim 6, wherein the processor confirms whether a position of the mark is correct based on a category and a coordinate corresponding to the mark, and determines whether the X-ray image is flipped.

9. The chest X-ray image analyzing method of claim 6, wherein,
when the preliminary determination result is yes, the processor corrects the X-ray image and inputs the X-ray image into the second judgment model;
when the preliminary determination result is no, the processor inputs the X-ray image into the second judgment model directly.

10. The chest X-ray image analyzing method of claim 6, wherein the second judgment model is a ResNeSt model.
